(19) United States
(12) Patent Application Publication
(10) Pub. No.: US 2025/0144792 A1
(43) Pub. Date: May 8, 2025

(54) ELASTIC ROBOT PLATFORM FOR CLEANING AND SCRUBBING WITH TENDON-DRIVEN JOINTS

(71) Applicant: Rutgers, The State University of New Jersey, New Brunswick, NJ (US)

(72) Inventors: Aaron D. Mazzeo, New Brunswick, NJ (US); Noah Harmatz, New Brunswick, NJ (US)

(73) Assignee: Rutgers, The State University of New Jersey, New Brunswick, NJ (US)

(21) Appl. No.: 18/934,468

(22) Filed: Nov. 1, 2024

Related U.S. Application Data
(60) Provisional application No. 63/547,047, filed on Nov. 2, 2023.

(51) Int. Cl. B25J 9/16; B08B 1/10; B08B 1/30; B25J 9/10; B25J 13/08; B25J 15/00

(52) U.S. Cl. CPC B25J 9/1633; B08B 1/10; B08B 1/30; B25J 9/1045; B25J 13/085; B25J 15/0019

(57) ABSTRACT

A robot arm having a series of rigid links including a first rigid link and a final rigid link, the links being operatively controlled via tendon-driven joints, each tendon-driven joint comprising a motorized spool configured to rotate in either of two directions and operatively coupled, via a cable assembly having an elastic portion, to a pulley configured to move a respective rigid link thereby. A controller adapts robot arm motion in response to position and force sensing signals. A tendon-driven joint may be implemented via one motor controlling the tension of two cables acting in opposing directions and coupled between respective ones of a pair of common-driven spools and a pair of pulleys.

### CROSS-REFERENCE TO RELATED APPLICATION

This application claims priority to U.S. Provisional Patent Application No. 63/547,047, filed on Nov. 2, 2023, entitled ELASTIC ROBOT PLATFORM FOR CLEANING AND SCRUBBING WITH TENDON-DRIVEN JOINTS (Attorney Docket No. RU-2024-024P), which application is incorporated herein by reference in its entirety.

### GOVERNMENT INTEREST

This invention was made with government support under National Science Foundation Research Traineeship (NRT)-FW-HTF Award No. 2021628. The government has certain rights in the invention.

### FIELD OF THE DISCLOSURE

The present disclosure generally relates to communications and, in particular, to Orthogonal Signal Division Multiple Access (OSDMA) communications systems.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Existing clean robot products in the market primarily focus on position control of mobile robots; that is, directing a robot to position itself over an area to be cleaned. Improvements are desired

### SUMMARY

Various deficiencies in the prior art are addressed by systems, methods, architectures, mechanisms, and apparatus providing a robot arm having a series of rigid links including a first rigid link and a final rigid link, the links being operatively controlled via tendon-driven joints, each tendon-driven joint comprising a motorized spool configured to rotate in either of two directions and operatively coupled, via a cable assembly having an elastic portion, to a pulley configured to move a respective rigid link thereby. A controller adapts robot arm motion in response to position and force sensing signals. A tendon-driven joint may be implemented via one motor controlling the tension of two cables acting in opposing directions and coupled between respective ones of a pair of common-driven spools and a pair of pulleys.

Various deficiencies in the prior art are addressed by systems, methods, architectures, mechanisms, and apparatus providing a low-cost, lightweight robot platform using elastic cables and rigid links to merge the properties of soft robots with rigid robot arms, wherein in some embodiments a mechanism combines the tendons for two directions of rotational motion of a robotic link onto one shaft, which significantly reduces the control requirements of the robot.

Further described is an illustrative robot platform capable of scrubbing contaminated surfaces via a multiple link arm (e.g., a two-link arm) controlled via a tendon-driven mechanism (TDM) with one motor controlling the tension of two cables acting in opposing directions. Each tendon contains an elastic spring in series.

A robot according to one embodiment has a series of rigid links including a first rigid link and a final rigid link, wherein: the first rigid link having a proximal end fixedly coupled to a first pulley and a distal end rotatably coupled to a second pulley, the first pulley configured to move the first rigid link in response to rotation of the first pulley, the second pulley fixedly coupled to an adjacent rigid link and configured to move the adjacent rigid link in response to rotation of the second pulley, the final rigid link having a proximal end fixedly coupled to a second pulley of an adjacent rigid link a distal end coupled to a force sensor and a tool, the second pulley of the adjacent rigid link configured to move the final rigid link in response to rotation of the second pulley of the adjacent rigid link, the tool configured to transmit a force toward a surface to be worked, the force sensor configured to generate a signal indicative of the transmitted force; each of the pulleys being coupled to a respective spool via a respective cable assembly looped therebetween to provide thereby respective tendon-driven joints configured for manipulating respective rigid links, each cable assembly comprising at least an elastic cable portion; each of the spools being rotatably driven in either of two directions of rotational motion by a respective motor; and a controller, configured to cause the motors to move the tool against the surface to be worked in accordance with desired position and force.

Additional objects, advantages, and novel features of the invention will be set forth in part in the description which follows and will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, explain the principles of the present invention.

FIG. 1 depicts a high-level block diagram of a system according to various embodiments;

FIG. 2 depicts the clockwise (CW) and counter-clockwise (CCW) actions of a pair of spools 120 coupled to a common shaft 215 that is driven by motor 110;

FIG. 3 graphically illustrates various forces associated with a contaminant;

FIG. 4 depicts a schematic representation of robot linkages, such as discussed herein with respect to the various embodiments;

FIGS. 5A-5B depict exemplary controllers suitable for use in the embodiments described herein;

FIG. 6 illustrates a method or design flow according to various embodiments.

FIG. 7 illustrates a modification of a control topology according to an embodiment;

FIG. 8 illustrates an embodiment of the robot 100 of FIG. 1; and

FIG. 9 illustrates a top view of the robot 100 of FIG. 1

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art and are to be construed as being without limitation to such specifically recited examples and conditions. Additionally, the term, “or” as used herein, refers to a non-exclusive or, unless otherwise indicated (e.g., “or else” or “or in the alternative”). Also, the various embodiments described herein are not necessarily mutually exclusive, as some embodiments may be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

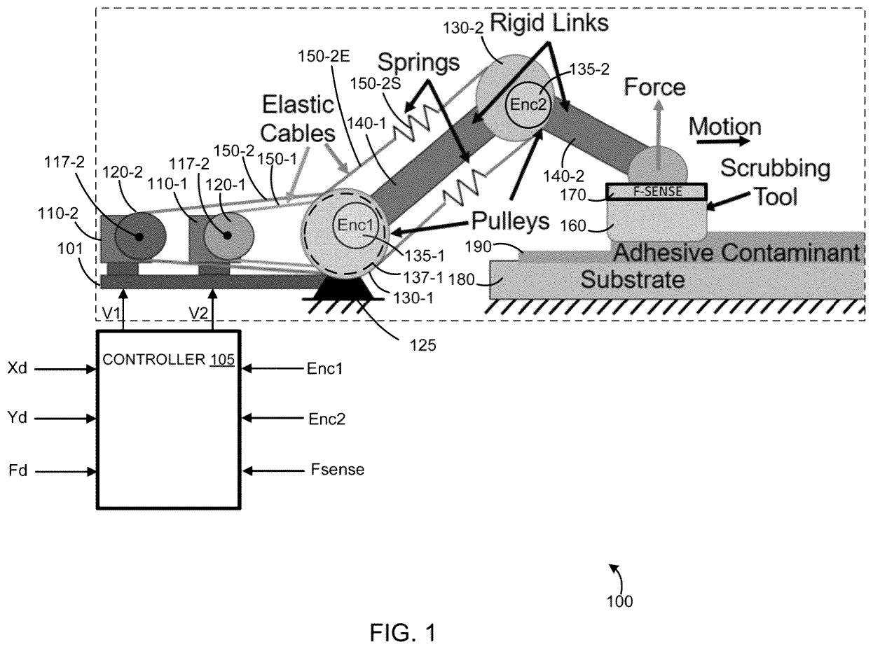

FIG. 1 depicts a high-level block diagram of a system according to various embodiments. The system 100 of FIG. 1 may be configured to implement a scrubbing robot configured to urge a scrubbing tool against a substrate to remove or reduce an adhesive contaminant disposed upon the substrate. A pair of motors drive a set of series elastic actuators (SEAs) consisting of elastic cables and springs. The SEAs actuate two rigid links. An end effector travels across a substrate with an adhesive contaminant. A scrubbing tool removes the contaminant as the robot passes it across the substrate. A force sensor measures the normal force which the robot exerts upon the surface. A controller adjusts the trajectory of the robot to maintain a desired force profile during scrubbing.

As depicted in FIG. 1, the system 100 is directed to a serial manipulator type of robot having an arm formed as a series of rigid links (illustratively two rigid links) including a first rigid link and a final rigid link, each link being associated with a respective tendon-driven joint, the robot being configured to urge a tool (illustratively a scrubbing tool) against a surface to remove an adhesive contaminant therefrom. It will be appreciated that other use cases and applications of scrubbing tools and other tools are contemplated herein with respect to the various embodiments, such as for polishing surfaces, rubbing services, sanitizing services, shaping services and so on. The services may be flat or contoured. The surfaces may be made of different surface substrates such as metal, stone, polymer, plant or animal tissue, and so on.

Referring to FIG. 1, a first rigid link 140-1 has a proximal end fixedly coupled or secured to first pulley 130-1 and a distal end rotatably coupled to second pulley 130-2. The first pulley 130-1 is rotatably mounted on a freely moving shaft of a base 125 and configured to move the first rigid link 140-1 in response to rotation of the first pulley 130-1 about a shaft (not shown). The second pulley 130-2 is fixedly coupled or secured to an adjacent rigid link 140 (illustratively the second or final rigid link 140-2 as depicted) and configured to move the adjacent rigid link 140-2 in response to rotation of the second pulley 130-2 about a shaft (not shown).

The final rigid link 140-2 has a proximal end fixedly coupled to the second pulley 130-2 of the first rigid link 140-1 and a distal end coupled to a force sensor 170 and a tool 160. The second pulley 130-2 of the adjacent rigid link 140-1 is configured to move the final rigid link 140-2 in response to rotation of the second pulley 130-2 of the adjacent (first) rigid link 140-1. The tool 160 may be thereby urged toward a surface to be worked such as a substrate 180 having disposed thereon a contaminant 190 (e.g., an adhesive contaminant) with a force F such that by causing the tool to move in a scrubbing motion (e.g., back and forth across the surface of the substrate 180 with the force F applied) the contaminant 190 is removed in whole or in part. A force sensor 170 (e.g., a load cell) may be included within the tool 160 or proximate the distal end of the final rigid link 140-2 such that the force transmitted toward the surface to be worked may be measured. In various embodiments, the force sensor 170 is configured to generate a signal indicative of the transmitted force F for use by a controller 105.

Each of the first 130-1 and second 130-2 pulleys is coupled to a respective spool 120-1, 120-2 via respective cable assemblies 150-1, 150-2 looped or connected therebetween. The cable assemblies 150, force sensors 170, and controller 105 enable elastic tendon-driven robotic link/arm functionality as described herein, such as with respect to surface scrubbing, polishing, and other operations. The soft/rigid robot hybrid implementing both position control and force control as described herein with respect to the various embodiments provides a relatively complex dynamic system having a control system/methodology that may be implemented with various types of analog, digital, and combined analog/digital control mechanisms.

In continuous cable embodiments, a spool 120 is formed as a single spool driven by a shaft 117 rotated by a respective motor 110. The single spool 120 is coupled to a respective “joint” pulley 130 via a single cable assembly 150 forming a continuous loop around the spool 120, the “joint” pulley 130, and any idler pulleys 137 therebetween. In these embodiments, clockwise (CW) or counter-clockwise (CCW) rotation of the shaft 117 by the motor 110 results in corresponding CW/CCW rotation of the spool 120 and, therefore, CW/CCW rotation of the pulley 130.

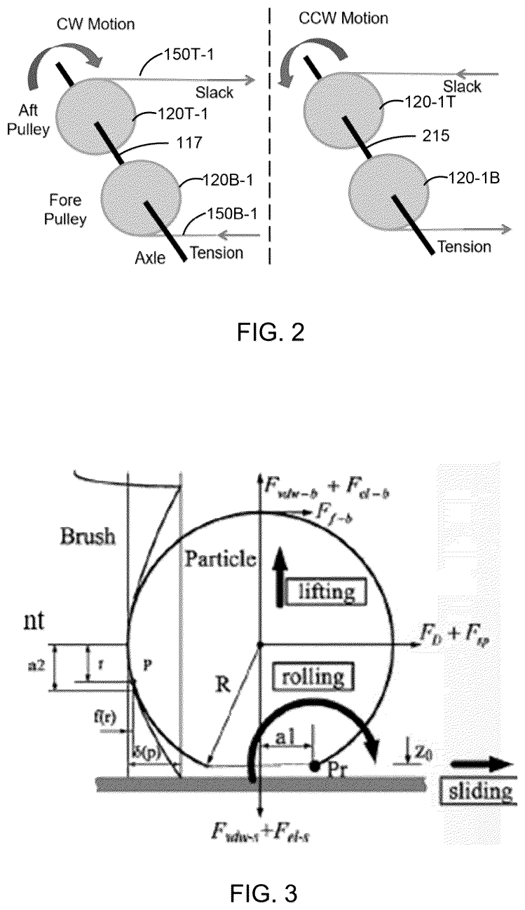

In discontinuous cable embodiments, such as additionally discussed below with respect to FIG. 2 and FIG. 9, a spool 120 is formed as a pair of spools 120 illustratively denoted as top spool 120T and a bottom spool 120B (or first/second spools 120, or inside/outside spools 120, etc.), wherein both top 120T and bottom 120B spools are driven by a common shaft 117 rotated by a respective motor 110. Similarly, the “joint” pulley 130 is formed as a pair of pulleys 130 illustratively denoted as top pulley 130T and bottom pulley 130B, wherein both top 130T and bottom 130B pulleys are secured to a common shaft or other common structure. The top spool 120T is coupled to the respective top pulley 130T via a first or top cable assembly 150T, which is secured to the rigid link 140 at a respective top anchor point APT. The bottom spool 120B is coupled to the respective bottom pulley 130B via a second or bottom cable assembly 150B, which is secured to the rigid link 140 at a respective top anchor point APB.

In these embodiments, clockwise (CW) or counter-clockwise (CCW) rotation of the shaft 117 by the motor 110 results in corresponding CW/CCW rotation of the top 120T and bottom 120B spools. However, during CW rotation, the top spool 120T is operative to decrease tension (slacken) of the first or top cable assembly 150T between the top spool 120T and the top pulley 130T, while the bottom spool 120B is operative to increase tension of the second or bottom cable assembly 150B between the bottom spool 120B and the bottom pulley 130B. Similarly, during CCW rotation, the top spool 120T is operative to increase tension of the first or top cable assembly 150T between the top spool 120T and the top pulley 130T, while the bottom spool 120B is operative to decrease tension (slacken) of the second or bottom cable assembly 150B between the bottom spool 120B and the bottom pulley 130B.

As such, while the various spools 120, pulleys 130, and idler pulleys 137 and so on depicted in the figures may comprise single spools 120, pulleys 130, and idler pulleys 137, or multiple spools 120, pulleys 130, and idler pulleys 137 sharing respective common rotating shafts as described above and herein.

Each of the cable assemblies 150-x, 150T-x, 150B-x, or portions thereof comprises at one respective elastic portion 150-xE, 150T-xE, 150B-xE. Optionally, the cable assemblies 150-x, 150T-x, 150B-x, or portions thereof may further comprise one or more spring portions 150-xS, 150T-xS, 150B-xS. The purpose of the elastic and (optional) spring portions is to provide a desired amount of elasticity, stiffness, damping, and other static/dynamic characteristics for each tendon-driven joint forming a tendon-driven mechanism (TDM). Further, each of the tendon-driven joints may be associated with the same or differing static/dynamic characteristics, such as determined for a particular application, purpose, loading, positioning, or other parameter(s) of interest.

As depicted in FIG. 1, first cable assembly 150-1 (continuous or discontinuous) is depicted as being looped directly between spool 120-1 and pulley 130-1, while second cable assembly 150-2 (continuous or discontinuous) is depicted as being looped between spool 120-2 and pulley 130-2 via an idler pulley 137-1 (drawn in dashed mode), wherein the idler pulley 137-1 is freely rotating about the same shaft as corresponding first pulley 130-1. If the robot arm utilized three (or more) rigid links 140, then each of additional idler pulleys 137-x would be freely rotating about the same shaft as their corresponding pulleys 130-x, such as coaxially disposed with respect to the both the first 130-1 and second 130-2 pulleys to support a third rigid arm.

As depicted in FIG. 1, the second cable assembly 150-2 is associated with the second rigid link 140-2 and comprises one or more elastic cable portions 150-2E and, optionally, one or more spring portions 150-2S, whereas the first cable assembly 150-1 is associated with the first rigid link 140-1 and comprises one or more elastic cable portions 150-1E and no spring portions 150-1S (though spring portions 150-1S may be used for the first cable assembly 150-1).

Each of the spools 120-1, 120-2 is couple to a respective motor 110-1, 110-2 via a respective shaft (not shown) so as to be rotatably driven by the respective motor 110-1, 110-2 in response to, illustratively, respective voltage signals V1, V2 provided by a controller 105.

The controller 105 is configured to cause the motors to move the tool 170 against the surface to be worked in accordance with a desired position and force, such as may be provided via position control signals Xd and Yd, and force signal Fd. In various embodiments, the actual force applied is measured by the force sensor 170. In various embodiments, the position of the pulleys 130-1 and 130-2 is indicated by respective optical or mechanical encoders 135-1, 135-2 mounted thereon or proximate to the respective pulleys 130-1 and 130-2. The optical or mechanical encoders 135-1, 135-2 may provide respective encoded position/rotation indicative signals Enc1, Enc2 to the controller 105 for further processing.

A load cell is used at the scrubbing pad or tool to determine the force of the scrubbing pad or tool applied to the surface, and to facilitate force compensation of the scrubbing pad or tool against the surface.

The controller 105 may be a PID controller (analog or digital) and is used to reach a desired pose or position of the robot links (or arm formed thereby) so as to introduce the scrubbing pad or other tool to the surface. Encoders 135 (e.g., optical, or mechanical encoders) provide position feedback to the elastic robot. Force control may be noisy, so various embodiments may have a controller configured to provide active disturbance rejection control or filtering. It is noted that the shock absorbing properties of the robot permit the use of a relatively simple controller 105 in various embodiments. Additional aspects of the controller 105 and the control loop mechanisms will be discussed in more detail below with respect to FIGS. 5A-5B.

Various embodiments use active disturbance rejection control (ADRC) as a control strategy to mitigate disturbances in force-based control. One ADRC scheme consists of a tracking differentiator (TD) and an estimated state observer (ESO). The controller uses feedback from the ESO and input from the TD to track the output y(t) of the system as compared to a reference signal r(t). ADRC compensates for any external disturbances and unmodeled dynamics within the system.

The embodiments of FIG. 1 contemplate a low-cost, lightweight robot platform capable of scrubbing contaminated surfaces via a multiple link arm (e.g., a two-link arm) where each arm is controlled via a tendon-driven mechanism (TDM) with one motor controlling the tension of two cables acting in opposing directions. Each tendon contains an elastic spring in series. The distal end of each tendon attaches to an anchor point on a robotic link. That is, the various embodiments combine the tendons for two directions of rotational motion of a robotic link onto one shaft (unlike conventional TDRs which require two shafts, one for clockwise motion and one for counterclockwise motion), which significantly reduces the control requirements of the robot.

Various embodiments further comprise tunable tension knobs added at the distal anchor point of each tendon at the joint side for manual tuning of tendon tension independent of motorized input.

It is noted that vibrations of a link after unloading were analyzed by the inventors to determine the stiffness and damping of the two links. The series elastic actuators or tendon-driven joints greatly reduce the stiffness of a link. Further, manually back driving the link to perform a loading/unloading test shows the improved elastic response of the link.

Various embodiments contemplate a 3 degree of freedom design wherein the robot uses series elastic actuators to actuate rigid links forming an arm of a serial manipulator or other robotic configuration. Motors within a torso or body portion drive elastic cables with springs in series with the elastic cables. The springs reduce the stiffness of the robot and permit shock absorption at the end effector. The various embodiments enable hybrid force-position control of, illustratively, an elastic tendon-driven scrubbing robot configured to clean contaminated surfaces with consistent trajectories of forced contact.

FIG. 2 depicts the clockwise (CW) and counter-clockwise (CCW) actions of a pair of spools 120T, 120B coupled to a common shaft 117 that is rotatably driven by motor 110 (not shown). Specifically, FIG. 2 depicts the use of top 120T-1 and bottom 120B-1 spools as discussed above with respect to FIG. 1, wherein each of the two distinct spools 120 on the single shaft 117 works in tandem to both let out cable (spool 1 or 120T-1) and pick up cable (spool 2 or 120B-2) with rotation in the same direction, since the spools have opposing wind orientations. As the shaft 117 rotates in one direction, one over-slung cable retreats while the under-slung cable advances. Rotating in the opposite direction changes the direction of motion in both cables. As such, one shaft can control tension in both directions for an attached link.

FIG. 3 graphically illustrates various forces associated with a contaminant. Specifically, an adhesive contaminant forms adhesive bonds with a substrate and cohesive bonds with other contaminant particles. A scrubber which removes a single particle must overcome the adhesion between the particle and the substrate. A scrubber which removes a multi-layer stain must remove the top layers first, which experience pure cohesion, before working down to the lower layers where the effects of adhesion begin to appear. The lowest layer is a mix of cohesion and adhesion. In the case of material where the work of adhesion is greater than the work of cohesion, the material will require more work to remove at the lower layers. The force which the scrubber exerts on the particle creates friction force Fr. The friction may cause slippage or rolling about the contact point on the surface. The particle also feels a van der Waals force Fydw in the direction of the scrubber which may overcome the adhesive force on the substrate. The resulting motion of the particle depends on the magnitude of the applied force and the adhesion between the particle and the substrate.

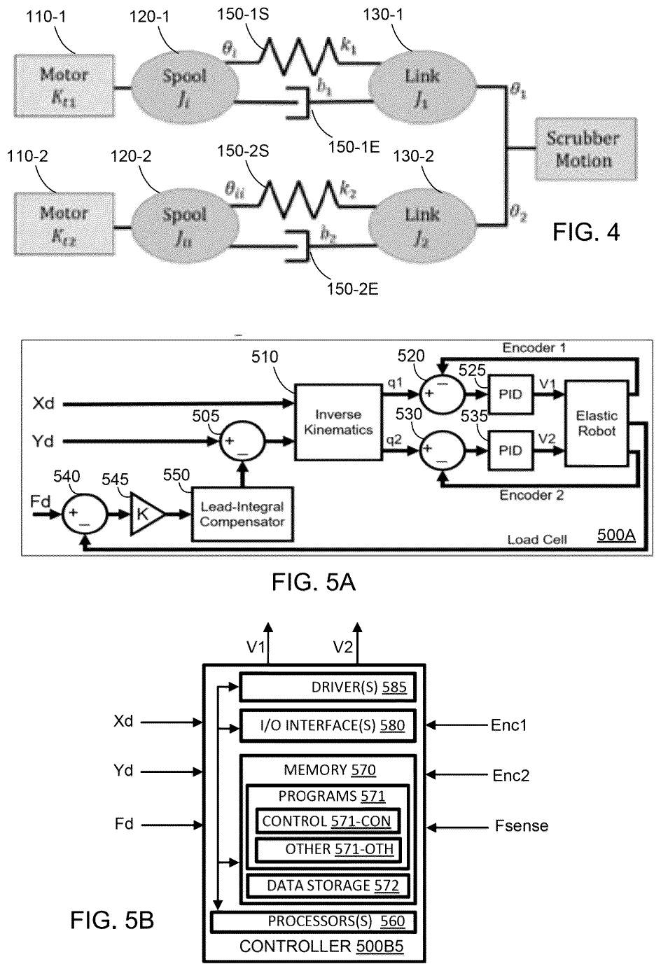

FIG. 4 depicts a schematic representation of robot linkages, such as discussed herein with respect to the various embodiments. Specifically, FIG. 4 depicts each of a pair of motors 110-1, 110-2 connected to a respective spool 120-1, 120-2. Each of the spools 120 has a respective connection 150 with a robotic link 130 through a Series Elastic Actuator. The kinematics of the two links determine the position of the scrubber at the end tip of the distal link.

FIG. 5A depicts an exemplary controller suitable for use in the embodiments described herein. Specifically, the controller 500A of FIG. 5A implements a control scheme for hybrid force-position control. The controller 500A accepts desired position (Xd and Yd) and desired force (Fd) data. An inverse kinematics solver 510 responsively outputs desired joint angles (q1 and q2) which are respectively coupled to first proportional-integral-derivative (PID) controller 525 and second PID controller 535, which respectively generate first motor voltage signal V1 and second motor voltage signal V2 for use by a robot assembly, such as robot 100 of FIG. 1.

That is, a position-control loop uses PID-based error control to achieve desired joint positions of the robotic links to reach a desired end-effector position in space. The PID controllers 525, 535 output voltages (V1 and V2) to the DC motors on the robot. Encoders (e.g., 135) on the robot output the position of the motors as feedback for the PID blocks. A lead-integral compensator 550 computes the error between Fd and feedback from a load cell on the robot to adjust the vertical position of the end effector with respect to a surface.

As depicted in FIG. 5A, a first summation module 520 is used to offset the kinematics module 510 output signal Q1 in accordance with the first encoder signal Enc1 generated by the first encoder 135-1 of the first pulley 130-1.

As depicted in FIG. 5A, a second summation module 530 is used to offset the kinematics module 510 output signal Q2 in accordance with the second encoder signal Enc2 generated by the second encoder 135-2 of the second pulley 130-2.

As depicted in FIG. 5A, the force signal Fsense received from the force sensor 170 is used by a third summation module 540 to offset received force indicative data Fd to provide an remaining force signal Fr for processing by K 545 and a lead-integral compensator 550 configured to provide a force compensation signal to a fourth summation module 505 which responsively reduced an amount of Y-position Yd data to be processed by the inverse kinematics module 510. Specifically, the lead integral compensator 550 accepts force feedback from the load cell (F-sense) to adjust the desired pose to maintain a constant force during contact. Tuning the compensator reduces the disturbances of force measurements acting on the scrubber during sliding/scrubbing contact.

### System Characterization & Controller Operation

The following terms/equations may be used within the context of the various embodiments to define the motion for a DC-Motor-Driven Series Elastic Actuator such as the multi-link arm described herein with respect to the various figures.

The speed of a DC motor (e.g., 110-1, 110-2) is based on input voltage applied thereto V_{b}(t) and may be defined as:

$${V}_{b} ( t ) = {K}_{b} \frac{d θ ( t )}{dt} \qquad ( 1 )$$

where θ is the angle of the motor shaft and K_{b} is the back-EMF constant of the motor.

The torque of a DC motor (e.g., 110-1, 110-2) is based on input current applied thereto τₘ(t) and may be defined as:

$${τ}_{m} ( t ) = {K}_{t} {i}_{a} ( t ) \qquad ( 2 )$$

where Kₜ is the torque constant of the motor and iₐ is armature current.

The voltage balance equation for the armature of a DC motor may be defined as:

$${i}_{a} ( t ) {R}_{a} + {L}_{a} \frac{{di}_{a} ( t )}{dt} + {V}_{b} ( t ) = {V}_{a} ( t ) \qquad ( 3 )$$

where iₐ is armature current, Rₐ is armature resistance, Lₐ is armature inductance, Vₚ is motor input voltage, and Vₐ is armature voltage.

The equation of motion for the motor-side dynamics of an SEA may be defined as:

$${J}_{m} \ddot{θ} ( t ) + {B}_{m} \dot{θ} ( t ) + k θ ( t ) - kq ( t ) = {τ}_{m} ( t ) \qquad ( 4 )$$

where Bₘ is the damping of the motor, Jₘ is the inertial load of the motor, k is the stiffness of the SEA, and τₘ is torque applied by the motor.

The equation of motion for the link-side dynamics of an SEA may be defined as:

$${J}_{L} \ddot{q} ( t ) + {b}_{L} \dot{q} ( t ) + kq ( t ) - k θ ( t ) - \frac{mgL}{2} cos ( q ( t ) ) = 0 \qquad ( 5 )$$

where J_{L} is the moment of inertia of the link, b_{L} is the damping coefficient of the link, m is the mass of the link, and L is the link length.

The equation of motion for a rotating link based on input torque may be defined as:

$$τ = M \ddot{q} + C \dot{q} + Kq + G \qquad ( 6 )$$

where τ is applied torque, M is inertia matrix, C is damping matrix, K is stiffness matrix, G is nonlinear gravity matrix, and q is the angular position of the links.

The state variable definitions for state-space formulation, illustratively displacement and velocity of links 1 and 2, may be expressed as:

$${x}_{1} = \dot{{q}_{1}} = \dot{{x}_{3}} ; {x}_{2} = \dot{{q}_{2}} = \dot{{x}_{4}} \qquad ( 7 )$$

The input variable definitions may be expressed as:

$${τ}_{1} = {u}_{1} , {τ}_{2} = {u}_{2} \qquad ( 8 )$$

The definition of nonlinear gravity terms G1 and G2 based on angular positions of links may be expressed as:

$${G}_{1} = \frac{{m}_{1} gL}{2} cos ( {x}_{3} ) + {m}_{2} g ( {L}_{1} cos ( {x}_{3} ) + \frac{{L}_{2}}{2} cos ( {x}_{3} + {x}_{4} ) ) \qquad ( 9 A )$$

$${G}_{2} = \frac{{m}_{2} {gL}_{2}}{2} cos ( {x}_{3} + {x}_{4} ) \qquad ( 9 B )$$

The state-space matrix formulation of equation of motion for a 2-link arm may be expressed as:

$$[ \begin{matrix}\dot{{x}_{1}} \\ \dot{{x}_{2}}\end{matrix} ] = \frac{- C}{M} [ \begin{matrix}{x}_{1} \\ {x}_{2}\end{matrix} ] + {M}^{- 1} [ \begin{matrix}{u}_{1} \\ {u}_{2}\end{matrix} ] - \frac{K}{M} [ \begin{matrix}{x}_{3} \\ {x}_{4}\end{matrix} ] - {M}^{- 1} [ \begin{matrix}{G}_{1} ( {x}_{3} , {x}_{4} ) \\ {G}_{2} ( {x}_{4} )\end{matrix} ] \qquad ( 11 A )$$

$$[ \begin{matrix}\dot{{x}_{1}} \\ \dot{{x}_{2}} \\ \dot{{x}_{3}} \\ \dot{{x}_{4}}\end{matrix} ] = [ \begin{matrix}{C}_{1} / {J}_{1} & 0 & 0 & 0 \\ 0 & {C}_{2} / {J}_{2} & 0 & 0 \\ 1 & 0 & 0 & 0 \\ 0 & 1 & 0 & 0\end{matrix} ] [ \begin{matrix}{x}_{1} \\ {x}_{2} \\ {x}_{3} \\ {x}_{4}\end{matrix} ] - [ \begin{matrix}1 / {J}_{1} & 0 & 0 & 0 \\ 0 & 1 / {J}_{2} & 0 & 0 \\ 0 & 0 & 0 & 0 \\ 0 & 0 & 0 & 0\end{matrix} ] [ \begin{matrix}{u}_{1} \\ {u}_{2} \\ 0 \\ 0\end{matrix} ] - \qquad ( 11 B )$$

$$[ \begin{matrix}{K}_{1} / {J}_{1} & 0 & 0 & 0 \\ 0 & {K}_{2} / {J}_{2} & 0 & 0 \\ 1 & 0 & 0 & 0 \\ 0 & 1 & 0 & 0\end{matrix} ] [ \begin{matrix}{x}_{1} \\ {x}_{2} \\ {x}_{3} \\ {x}_{4}\end{matrix} ] - [ \begin{matrix}1 / {J}_{1} & 0 & 0 & 0 \\ 0 & 1 / {J}_{2} & 0 & 0 \\ 0 & 0 & 0 & 0 \\ 0 & 0 & 0 & 0\end{matrix} ] [ \begin{matrix}{G}_{1} ( {x}_{3} , {x}_{4} ) \\ {G}_{2} ( {x}_{4} ) \\ 0 \\ 0\end{matrix} ]$$

The various controller functions are now described, such controller functions being implemented as described herein with respect to the various embodiments, such as to provide PID position control for each motor in the robot, force compensation to adjust the height of the end effector based on force feedback, and so on. The robot adjusts the desired height of the end effector to maintain a desired force. A kinematics function inside the robot controller computes the corresponding joint angles.

Position Controller for Motor. The PID position control for motors in the robot may operate in accordance with the following:

$${G}_{c} = {K}_{p} + \frac{{K}_{i}}{s} + {K}_{d} s = \frac{{K}_{d} ( {s}^{2} + \frac{{K}_{p}}{{K}_{d}} s + \frac{{K}_{i}}{{K}_{d}} )}{s} \qquad ( 12 )$$

where Kₚ is proportional gain, Kᵢ is integral gain, and K_{d} is derivative gain. G_{c} is the total gain of the controller.

Force Compensation Controller. The force compensation controller adjusts the height of the end effector based on force feedback, such as via a lead-integral compensator operating as follows:

$${C}_{c} = ( {C}_{p} + \frac{{C}_{i}}{s} ) \frac{α τ s + 1}{τ s + 1} \qquad ( 13 )$$

where Cₚ is proportional gain, Cᵢ is integral gain, τ is lead time, and a is proportional coefficient for lead time.

Compensated height for end effector. The robot adjusts the desired height of the end effector to maintain a desired force, such as via a kinematics function inside the robot controller computing the corresponding joint angles by operating as follows:

$${y}_{c} ( t ) = {C}_{c} \frac{{F}_{d} ( t ) - {F}_{ee} ( t )}{{k}_{sp}} = \frac{1}{{k}_{sp}} ( {F}_{d} + {k}_{sp} {y}_{ee} ( t ) ) \qquad ( 14 )$$

where F_{d} is desired force, Fₑₑ is measured force at end effector, kₛₚ is stiffness of sponge (or scrubbing tool, or other type or tool), yₑₑ is measured height of end effector, and y_{c} is controlled height of the sponge.

The controller 105 and other controllers described herein with respect to the various embodiment control various motors and

FIG. 5B depicts an exemplary controller suitable for use in the embodiments described herein. Specifically, the controller 500B of FIG. 5B comprises a digital controller or computer implementing via hardware or a combination or hardware and software substantially the same functions described above with respect to the controller 500A FIG. 5A.

As depicted in FIG. 5B, the controller 500B includes one or more processors 560, a memory 570, input-output (I/O) interface(s) 580, and driver circuitry 585. The processor(s) 560 are coupled to each of memory 570, input-output (I/O) interface(s) 580, and driver circuitry 585. The processor(s) 560 are configured for controlling the operation of controller 500B, including operations supporting the methodologies described herein with respect to the various embodiments. Similarly, the memory 570 is configured for storing information suitable for use by the processor(s) 510. Specifically, memory 570 may store programs 571, data 572 and so on. Within the context of the various embodiments, the programs 571 and data 572 may vary depending upon the specific functions implemented by the controller 500B. For example, as depicted in FIG. 5, the programs portion of 571 of memory 570 includes a control program 571-CON implementing the various functions described above with respect to FIG. 5A, as well as various optional programs 571-OTH alone or in combination to implement various computing, control, management, and/or other functions discussed in this specification.

Generally speaking, the memory 570 may store any information suitable for use by the controller 500B in implementing one or more of the various methodologies or mechanisms described herein. It will be noted that while various functions are associated with specific programs or databases, there is no requirement that such functions be associated in the specific manner. Thus, any implementations achieving the functions of the various embodiments may be used.

The I/O interface(s) 580 may be coupled to one or more presentation devices (not shown) such as associated with display devices for presenting information to a user, one or more input devices (not shown) such as touch screen or keypad input devices for enabling user input, and/or interfaces enabling communication between the controller 500B and other computing, networking, presentation or other local or remote input/output devices (not shown).

The drivers 585 provide output signals V1, V2, . . . . VN suitable for use in driving motors 110 such as described above with respect to FIG. 1.

As such, the various functions depicted and described herein may be implemented at the elements or portions thereof as hardware or a combination of software and hardware, such as by using a general-purpose computer, one or more application specific integrated circuits (ASIC), or any other hardware equivalents or combinations thereof. In various embodiments, computer instructions associated with a function of an element or portion thereof are loaded into a respective memory and executed by a respective processor to implement the respective functions as discussed herein. Thus, various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory or stored within a memory within a computing device operating according to the instructions.

It is contemplated that some of the steps discussed herein as software methods may be implemented within special-purpose hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in tangible fixed or removable media, transmitted via a data stream in a broadcast or other tangible signal-bearing medium, and/or stored within a memory within a computing device operating according to the instructions.

Although primarily depicted and described as having specific types and arrangements of components, it will be appreciated that any other suitable types and/or arrangements of components may be used for controller 500B.

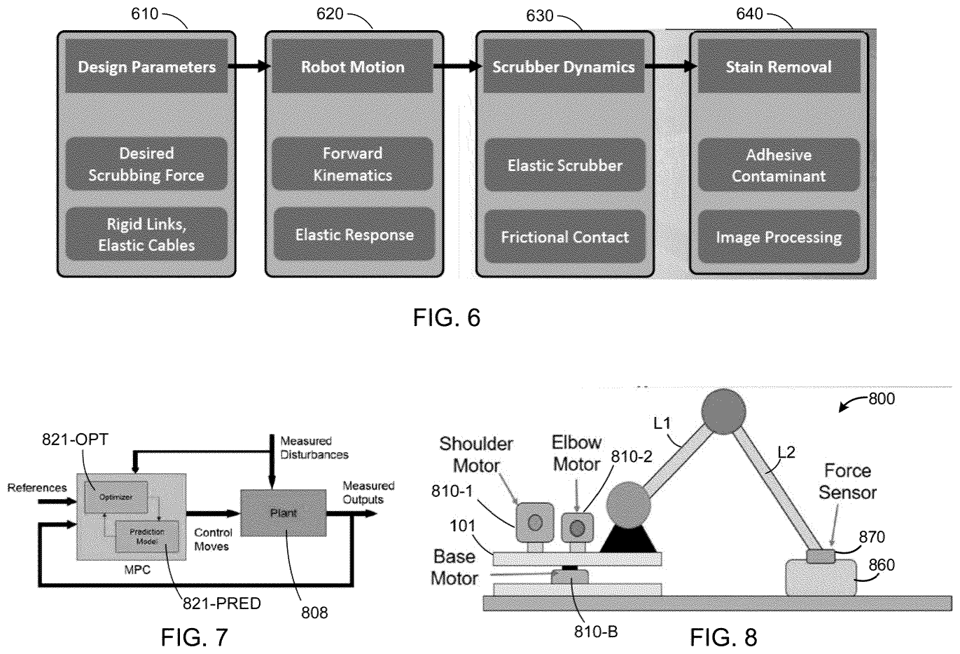

FIG. 6 illustrates a method or design flow according to various embodiments. Specifically, the method or design flow 600 of FIG. 6 contemplate a determination of design parameters 610 (e.g., desired scrubbing force, number of rigid links 140, number/type of cable assemblies 150, etc.) which thereby define the available robot motions 620 (e.g., forward kinematics, elastic response, etc.), which thereby define the available tool (e.g., scrubber) dynamics 630 (elastic scrubber, frictional contact, etc.), which defines a likely outcome (e.g., stain removal) level or suitability to application 640 (adhesive contaminant removal, image processing, etc.).

Specifically, the method or design flow 600 of the scrubbing robot is configured to provide a robot be able to exert a desired scrubbing force on a surface within a workspace. This scrubbing force dictates the output torque requirements of the driving motors as well as the structural design of the rigid links. The torque of the motors leads to a loading-unloading tension within the SEAs which creates a designed fatigue requirement for the springs and cables. The motion of the robotic links controls the dynamics of the scrubbing tool during contact with a surface. The force which the robot applies and the material properties of the scrubber determine the wear rate of the adhesive contaminant. An image processing algorithm may be used to measure the wear rate.

FIG. 7 illustrates a modification of the control topology 705 so as to include prediction model 721-PRED and an optimizer 721-OPT modules, such as may be implemented in the controller 500B of FIG. 5B.

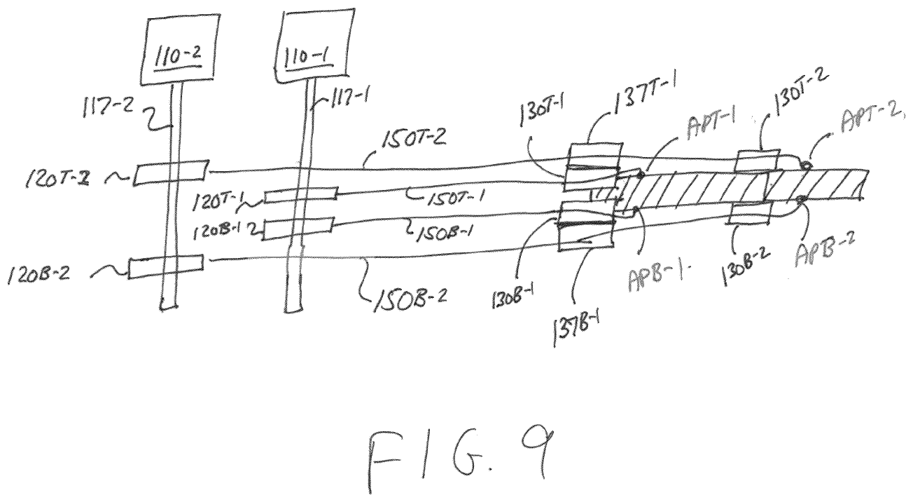

FIG. 8 illustrates an embodiment of the robot 100 of FIG. 1 modified to include an optional base 802 upon which is disposed a base motor 810-B configured to allow the robot supporting platform 101 to rotate so at to extend its cleaning pad or other endpoint device over a wide area. The system 800 of FIG. 1 may be configured to implement a scrubbing robot configured to urge a scrubbing tool against a substrate to remove or reduce an adhesive contaminant disposed upon the substrate. A pair of motors 810-1, 810-2 sits atop a rotating base 101. Each motor controls the motion of one robotic link L1, L2 such as described above with respect to the system 100 of FIG. 1 (i.e., each of the robotic links L1, L2 comprising respective rigid portions, cable assemblies with elastic and spring portions, pulleys, etc.). A third motor 810-B controls the rotation of the robot about the vertical axis to facilitate scrubbing in a circular motion. A scrubbing tool 860 sits at the distal end of the robot (i.e., the final link L2). A force 860 sensor embedded within the scrubbing tool measures the force during scrubbing.

As depicted and described herein, various embodiments provide a low-cost, lightweight robot platform capable of scrubbing contaminated surfaces via a multiple link arm (e.g., a two-link arm) controlled via a tendon-driven mechanism (TDM) with one motor controlling the tension of two cables acting in opposing directions. Each tendon contains an elastic spring in series. The distal end of each tendon attaches to an anchor point on a robotic link.

Various embodiments use elastic cables and rigid links to merge the properties of soft robots with traditional robot arms. The mechanism combines the tendons for two directions of rotational motion of a robotic link onto one shaft (unlike conventional TDRs which require two shafts, one for clockwise motion and one for counterclockwise motion), which significantly reduces the control requirements of the robot.

Optional tunable tension knobs may be added at the distal anchor point of each tendon at the joint side for manual tuning of tendon tension independent of motorized input. The tunable tension knobs may be manually or automatically operated to increase or decrease tension of a tendon (i.e., of an elastic portion 150-xE or spring portion 150-xS of a cable assembly 150). For example, a tuning knob may be used to move or displace a tuning pulley cooperating with a cable assembly 150 such that the tension of the cable assembly 150 is increased or decreased. This process may be automated via an additional control loop.

Optionally, cables or tendons 150 having tunable elasticity may be used so as to effect a force-controlled trajectory of a serial manipulator. Optionally, an end-effector of such a serial manipulator may include an implement for scrubbing, polishing, cleaning, grinding, surface-treatments, removal of contaminants, and the like. Optionally, the entire serial manipulator including the end-effector with its implement for applying force may be underactuated and apply a restoring force to disturbances or input from the environment.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof.

What is claimed is:

1. A robot having a series of rigid links including a first rigid link and a final rigid link, wherein:
the first rigid link having a proximal end fixedly coupled to a first pulley and a distal end rotatably coupled to a second pulley, the first pulley configured to move the first rigid link in response to rotation of the first pulley, the second pulley fixedly coupled to an adjacent rigid link and configured to move the adjacent rigid link in response to rotation of the second pulley,
the final rigid link having a proximal end fixedly coupled to a final pulley of an adjacent rigid link a distal end coupled to a force sensor and a tool, the second pulley of the adjacent rigid link configured to move the final rigid link in response to rotation of the second pulley of the adjacent rigid link, the tool configured to transmit a force toward a surface to be worked, the force sensor configured to generate a signal indicative of the transmitted force;
each of the pulleys being coupled to a respective spool via a respective cable assembly coupled therebetween to provide thereby a respective tendon-driven joint configured for manipulating a respective rigid link, each cable assembly comprising at least an elastic cable portion;
each of the spools being rotatably driven in either of two directions of rotational motion by a respective motor; and
a controller, configured to cause the motors to move the tool against the surface to be worked in accordance with desired position and force.

2. The robot of claim 1, wherein the robot comprises only a first rigid link and a second rigid link.

3. The robot of claim 1, wherein the robot comprises at least three rigid links.

4. The robot of claim 2, wherein the robot is mounted on a rotating platform having associated with it a base motor configured to rotate the series of rigid links towards the surface to be worked.

5. The robot of claim 1, wherein the controller comprises a proportional-integral-derivative (PID) controller.

6. The robot of claim 1, wherein each motor is controlled by a respective controller, and each controller is programmed via a respective programming signal derived using an inverse kinematic process.

7. The robot of claim 1, wherein each cable assembly further comprising a spring portion.

8. The robot of claim 1, wherein the tool comprises a scrubbing tool and the controller is configured to cause the scrubbing tool to move against the surface to be worked in accordance with a surface decontamination motion.

9. The robot of claim 1, wherein:
each spool comprising a pair of spools fixedly mounted on a respective common shaft driven by the respective motor;
each pulley comprising a pair of pulleys rotatably mounted on a respective common shaft; and
each cable assembly comprising a pair of cable assemblies comprising respective elastic portions, a first of the pair of cable assemblies operatively coupling a first of the pair of spools and a first of the pair of pulleys, a second of the pair of cable assemblies operatively coupling a second of the pair of spools and a second of the pair of pulleys;
wherein motor operation driving the pair of spools in a first direction increases tension of the first of the pair of cable assemblies and decreases tension of the second of the pair of cable assemblies;
wherein motor operation driving the pair of spools in a second direction increases tension of the second of the pair of cable assemblies and decreases tension of the first of the pair of cable assemblies.

10. The robot of claim 9, wherein at least one of the pair of cable assemblies further comprising a spring portion.

11. A method of causing a robot to exert a desired scrubbing force on a surface within a workspace, the robot having a series of rigid links including a first rigid link and a final rigid link, the links being operatively controlled via tendon-driven joints, the method comprising:
determining torque requirements associated with the desired scrubbing force to be exerted;
determining forward kinematics of robot motion using elastic response of the tendon-driven joints driving the rigid links;
determining, for each tendon-driven joint, a respective more control loop configured to cause robot motion according to respective determined kinematics;
causing the robot to operate substantially in accordance with the determined kinematics of the tendon-driven joints to exert a scrubbing force on the surface via a scrubbing tool; and
adapting the determined kinematics in accordance with an exerted force sensor signal.
